(19) United States
(12) Patent Application Publication
(10) Pub. No.: US 2019/0183072 A1
(43) Pub. Date: Jun. 20, 2019

(54) VITICULTURAL CANE SUPPORT SYSTEM

(71) Applicant: Bryan Babcock, Santa Barbara, CA (US)

(72) Inventor: Bryan Babcock, Santa Barbara, CA (US)

(21) Appl. No.: 15/846,513

(22) Filed: Dec. 19, 2017

(51) Int. Cl. A01G 17/06

(52) U.S. Cl. CPC A01G 17/06

(57) ABSTRACT

A cane pedestal for support of grape vine canes incorporates a positioning shaft supported by wires extending between vine stakes. The positioning shaft extends upwardly above a top wire with a suspension arm located proximate a head of the positioning shaft. The suspension arm extends from the positioning shaft with a bight angularly oriented with respect to a vertical axis of the positioning shaft. The suspension arm configured to receive and support grape vine canes.

### BACKGROUND

### Field

This invention relates generally to the field of viticulture, in particular to the design and manufacture of grapevine support systems and to methods for grapevine cane support and crop management, and more particularly, to a cane support pedestal employing a positioning shaft and suspension arm.

### Description of the Related Art

Vineyard management for both wine and table grapes has varied over many generations of farmers. With modern viticulture techniques consistency in crop yields and character particularly in wine grapes is being established. Such consistency is imperative for creation of high quality wines. European and American viticulturalists have developed several predominant infrastructures (“trellises”) with accompanying canopy manipulation techniques for managing wine producing vines. A prior art trellising approach for grape vines, Vertical Shoot Positioning (“VSP”), employs support wires extending between posts and with cordons or fruiting canes (“canes”) extending from the vine's trunks, supported horizontally by said wires approximately 24 inches above ground. Trunks are pruned to maintain this height. If cordons are established they are maintained yearly in this position. If fruiting canes are established, they are replaced by new canes yearly in this position. A series of upper wires are then used to vertically support the new seasonal shoots (“shoots”) extending from the cordons (or fruiting canes) with leaves forming the canopy of the vine above the cordons.

This requires that the yearly growth of shoots, grapes and leaves be supported above the cordons or fruiting canes which are basically in an unstable position relying solely on the support of the trellis wires both vertically and laterally.

This technique does not provide optimum conditions for machine harvesting, nor does it provide optimum spring frost protection, nor does it provide optimum human ergonomic conditions for canopy management in the vine's fruiting zone, nor does it provide conditions for the layering of fruiting canes in a cane pruned system, and requires significant infrastructure in the form of support wires and other devices to support the crop above the cordons or fruiting canes, along with the overall requirement of significant labor in order to place the vines each year up into the trellis, as well the significant labor that is necessary to prune the vines out of the structure at the end of each season.

It is therefore desirable to provide a novel infrastructure that supports the vines in a way that reduces the currently employed support structures as well as the costs required to operate them.

### SUMMARY

The embodiments disclosed herein overcome the shortcomings of the prior art by providing a cane support system which includes a positioning shaft supported by wires extending between vine stakes. The positioning shaft extends upwardly above a top wire. A suspension arm is located proximate an upper end of the positioning shaft and extends from the positioning shaft with a bight angularly oriented respective to a vertical axis of the positioning shaft. The suspension arm, in combination with the positioning shaft, provide a cane receptacle, configured to receive and support grape vine canes.

### BRIEF DESCRIPTION OF THE DRAWINGS

These and other features and advantages of the present invention will be better understood by reference to the following detailed description of exemplary embodiments when considered in connection with the accompanying drawings wherein:

FIG. 1 is an isometric view of an exemplary embodiment of a support pedestal;

FIG. 2 is a pictorial representation of an exemplary section of vineyard trellising employing the described embodiments of the support pedestals;

FIG. 3A is an isometric close up of the cane receptacle of the support pedestal of FIG. 1;

FIG. 3B is an isometric close up of an alternative embodiment of the support pedestal with two opposing support arms;

FIGS. 4A-4C are top, front and side detailed views of the cane receptacle of the pedestal of FIG. 3A;

FIG. 5 is a side view of a second embodiment of the suspension arm relieved from the vertical plane;

FIG. 6 is a side view of a third embodiment of the suspension arm extending beyond the vertical plane;

FIG. 7 is a side view of a fourth embodiment of the suspension arm with a semicircular planform;

FIG. 8 is an isometric closeup of a fifth embodiment of the suspension arm with a rectangular planform;

FIG. 9 is a pictorial representation of an alternative example of a attachment of the positioning shaft to support wires;

FIG. 10 is a pictorial representation of a grape vine trellis employing the embodiments herein;

FIG. 11 is a close up pictorial representation of flexible insertion of a cane into the cane receptacle of the support pedestal; and,

FIG. 12 is a representation of a vine having a trunk adjacent a stake in the vine trellis with canes extending through the pedestals supported by the cane receptacle.

### DETAILED DESCRIPTION

Embodiments shown in the drawings and described herein provide a viticultural method and system for alternative positioning of fruiting canes in individual grape vines at a higher level than normal prior art practice, nominally 48 to 60 inches with the trunk extending to that height. The canes are then laterally positioned outward from the vine's trunks and held by the pedestals which support the canes horizontally, but allow for rotation, or the significant pronation, of the canes within the supporting cane receptacles. At this higher level, as new shoot growth appears from the canes, instead of being supported above the cane, the canes pronate within the cane receptacles to allow the new growth to hang downward into natural positioning, which allows the weight of the vine's canopy and fruit to be borne by the pedestal, as opposed to being suspended on support wires. Positioning of the vineyard rows relative to a prevailing breeze additionally allows the force of the wind against the shoots and leaves to enhance the pronation of the canes, thereby delivering shoots and leaves to more natural hanging positions.

For descriptive purposes herein, early in a season, new growth is typically referred to as a “shoot”. A “cane” typically describes a mature shoot, one that has undergone a significant amount of lignification and has become pliable and/or woody. Canes produced in any given season are considered to be “first-year canes”. Canes held over into a second year to be employed as the source for the subsequent year's growth are considered to be “second-year wood, fruiting canes, or fruiting wood”. During winter pruning subsequent to a growing season, the first-year canes desired for the next year's growth are retained, as will be described subsequently, and the present system may be defined as “layered cane pruning”. The retained canes are laid out horizontally in an overlapping fashion between the vines. At each bud on the canes, a new shoot emerges the next spring. On the new shoots resides the new crop.

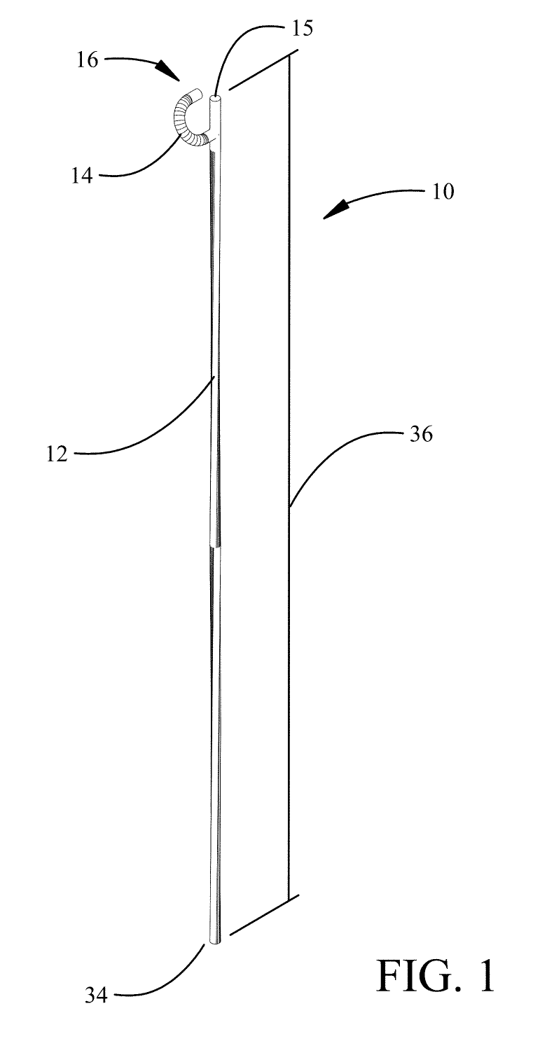

FIG. 1 shows an exemplary embodiment of a cane support pedestal 10 which incorporates a positioning shaft 12 and a suspension arm 14. The suspension arm 14 is located proximate an upper end of the positioning shaft 12, which, together, form a cane receptacle 16 at a top end 15 of the pedestal 10, as will be described in greater detail subsequently.

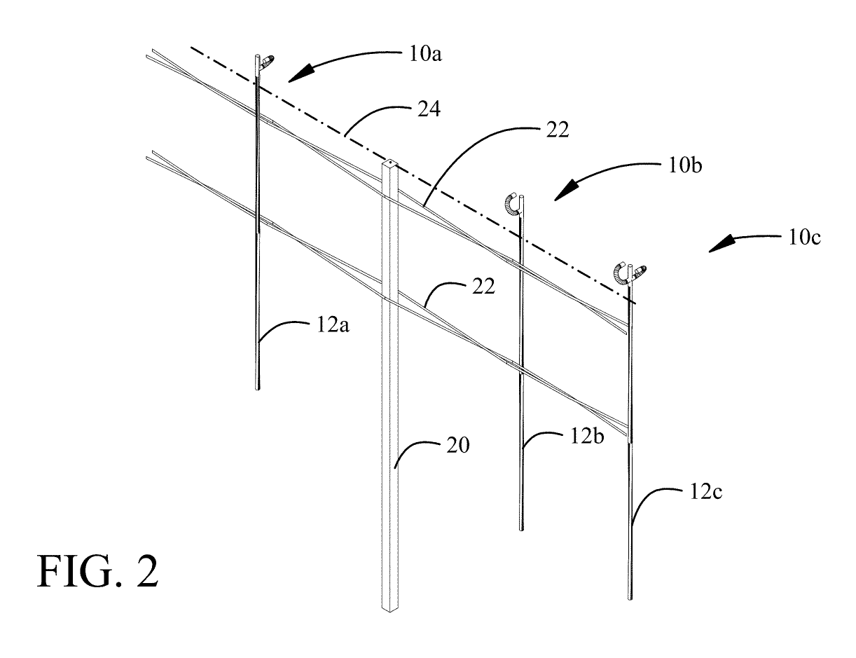

As shown in FIG. 2 the infrastructure employing the current embodiments employs vine stakes 20 placed at or near the trunks of the vines with support wires 22 extending laterally. In a first embodiment, cane pedestals 10a and 10b are supported by the positioning shafts 12a and 12b suspended from the support wires 22. In the exemplary embodiment, the suspension arms 14 are arcuate in shape, semicircular for the embodiment shown, to enhance the capturing and retaining of the canes within the cane receptacles 16. The suspension arms have an effective diameter to sufficiently hold the canes loosely but allow for the pronation of the canes without constraint. Pedestals will typically employ one suspension arm 14 on the position shaft 12. However, the pedestals may have opposing suspension arms to separately support canes extending from vines on either side.

As will be shown in greater detail subsequently, the support wires 22 suspend the positioning shafts 12a and 12b from below with the positioning shafts extending upwardly from the top wire. No wires are present in the zone of the fruiting canes or in the zone of the crop enhancing the fruiting canes' ability to pronate, thereby releasing most of the vine's new shoots to easily grow, with gravity, in a downward direction. With less congestion in the fruiting zone, and with the crop in a more shakable position higher off the ground, mechanical harvesting is greatly enhanced, as are the ergonomic conditions of vine canopy management in the fruiting zone, as is the overall symmetry and placement of the crop, which leads to a much higher degree of individuated cluster architecture, which helps to minimize late season bunch rot, which has the overall effect of preserving more crop while producing better wine.

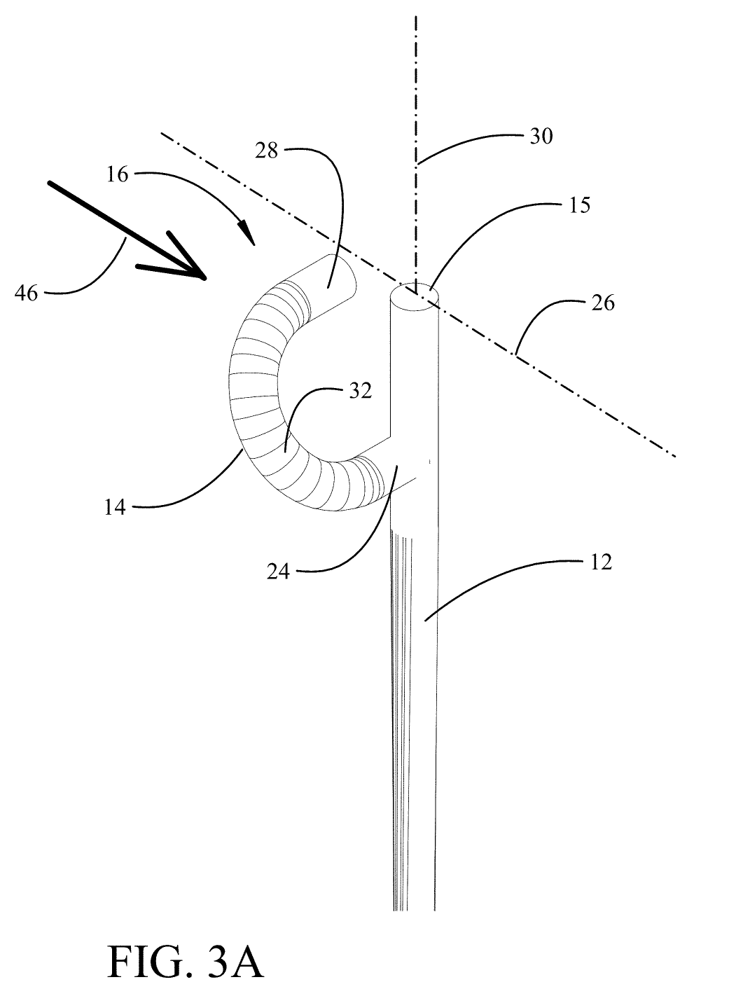

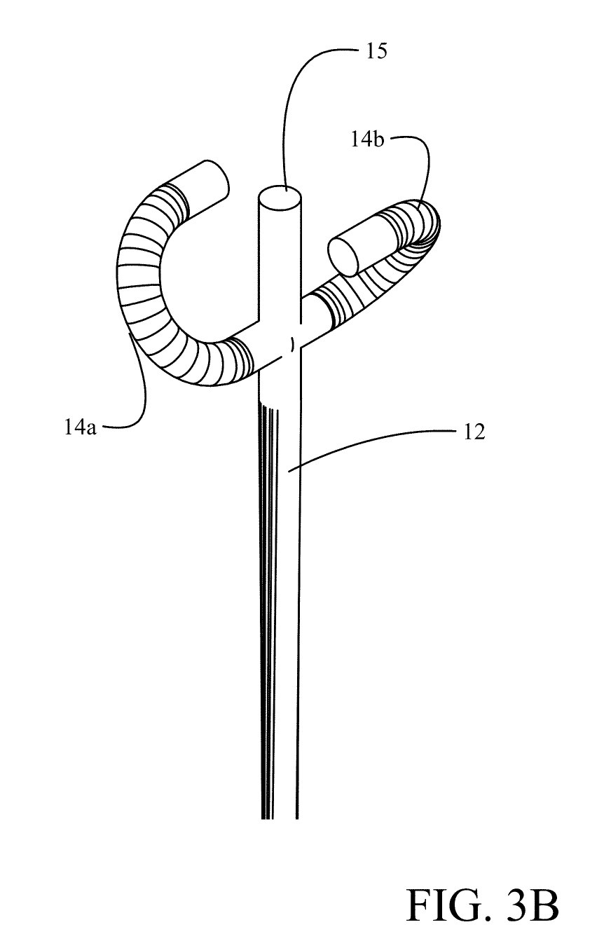

To establish vines in the support system as described for the embodiments above, vine trunks are allowed to grow to approximately 48 to 60 inches. Selected fruiting canes are horizontally entrained in the cane receptacles 16 at the top ends 15 of the pedestals 10, successfully capturing and suspending the canes at their pronatable portions. Use of two opposing suspension arms 14a, 14b for releasable support of the canes (shown in the FIG. 3B to be describe subsequently) allows separate lateral positioning of the opposing canes and employs the enhanced insertion geometry, to be described subsequently, for insertion of canes from both directions. As the fruit bearing shoots emerge from the canes, they gradually begin to be pushed downward by virtue of their increasing mass and by the encouragement of the pronation of the canes within the cane receptacle 16 of cane pedestals 10.

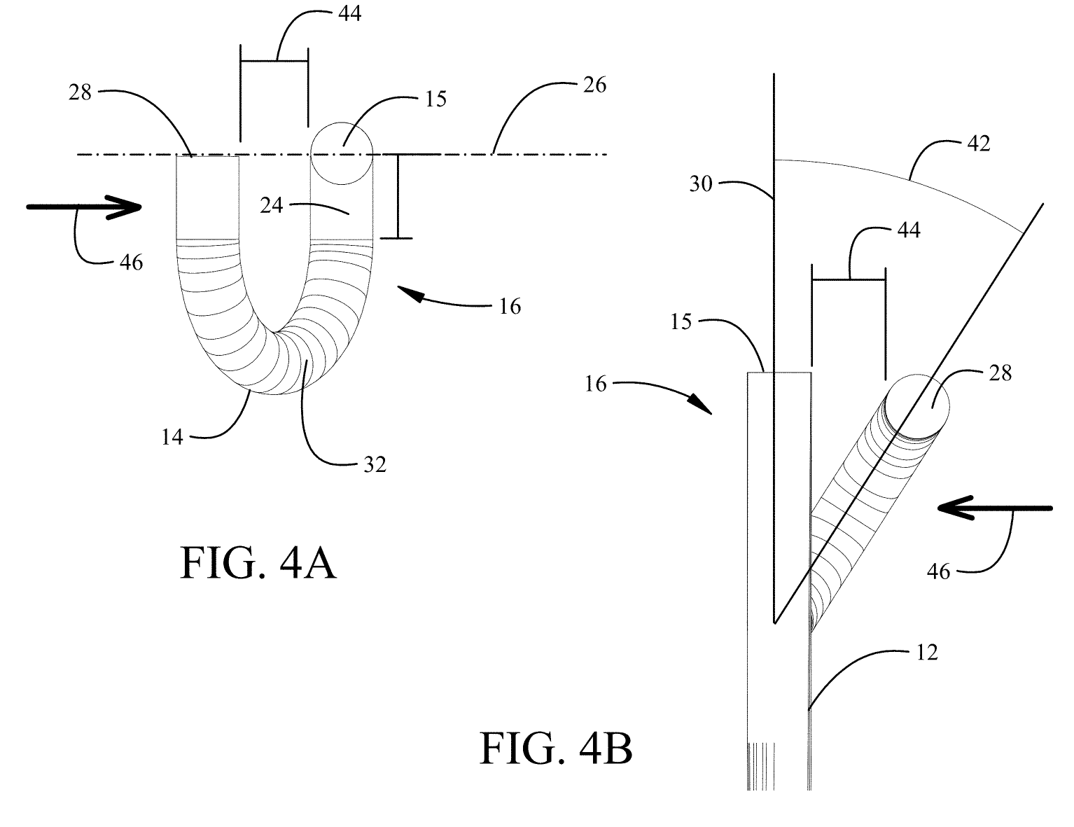

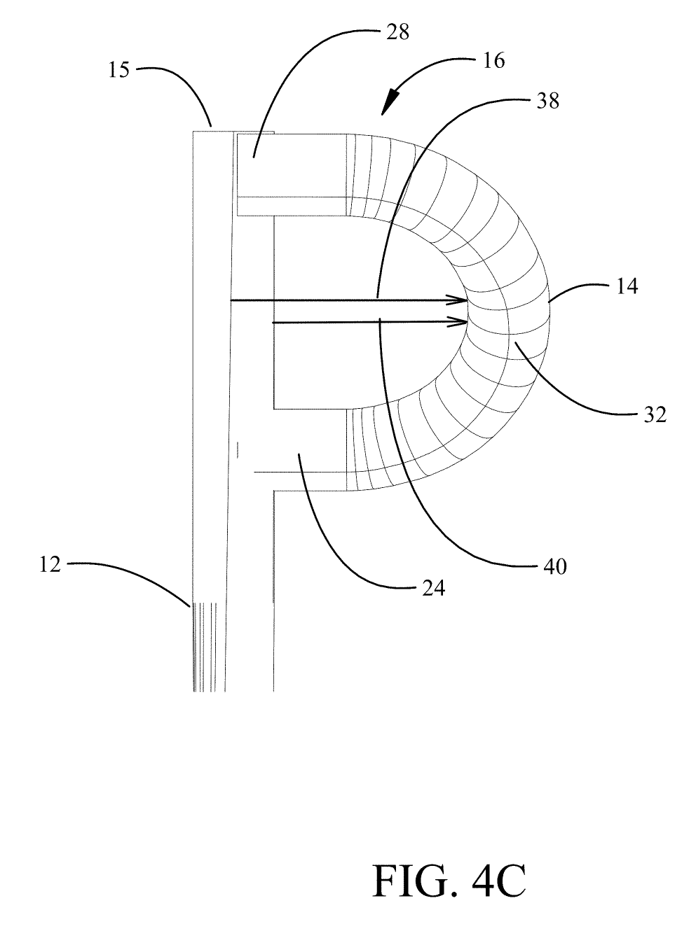

As seen in FIGS. 3A, 3B and 4A-4C, the structure and geometric arrangement of the positioning shaft 12 and suspension arm 14 are specifically defined to allow insertion of flexible fruiting canes which are then retained within the space (“eye”) of the cane receptacle 16 that is created by the relationship between the positioning shaft 12 and the suspension arm 14. A base 24 of the suspension arm 14 connects to the positioning shaft 12 substantially perpendicular to a vertical plane defined by a longitudinal axis 26 extending between vine stakes 20. A tip 28 of the suspension arm 14, distal on the suspension arm from the base 24, is angularly offset from a vertical axis 30 of the positioning shaft 12 as best seen in FIGS. 4A and 4B. The longitudinal axis 26 and vertical axis 30 reside in the vertical plane. The suspension arm incorporates a bight 32 between the base 24 and the tip 28. As seen in FIG. 3B, in alternative embodiments, suspension arms 14a and 14b may extend from each side of the positioning shaft 12 to received canes extending from opposite directions. Suspension arm 14b is merely a reverse mirror image of suspension arm 14a.

For stability and support in the support wires 22, the positioning shaft 12 has a minimum length of 12 inches. However, the shaft may extend from a top end 15 to a lower end 34 (seen in FIG. 1) up to a total length 36 (seen in FIG. 1) of 84 inches. The lower end 34 of the shaft may be inserted into the ground or make ground contact in certain applications. While shown in FIG. 2 as a two-wire support, alternative embodiments may employ a three-wire support.

In exemplary embodiments, the positioning shafts 12 may be circular or rectangular in cross section with a diameter or lateral length of between ⅜″ and ½″. The suspension arms 14 may similarly be circular or rectangular in cross section with a diameter or lateral dimension of between 3/32″ and ½″. While the bight 32 is shown as a semicircular planform connected to extending base 24 and tip 28 in the exemplary embodiments, the bight may be elliptical or rectangular in planform. As seen in FIG. 4C, the bight 32 provides a receiving diameter 38 (in a plane of the planform) between 1″ and 4″ and a minimum clearance 40 between the shaft 12 and inner surface of the bight 32 of between ¾″ and 4″ for loose support of the inserted canes throughout their growth.

As seen in FIGS. 4A and 4B, the suspension arm 14 has an angle 42 relative to the axis 30 of the positioning shaft 12 to provide a longitudinal insertion gap 44 of a minimum of ½″ between the positioning shaft 12 and the tip 28 of the suspension arm 14. The angle 42 provides a bias or lean of the suspension arm 14 toward the nearest adjacent vine stake 20 to receive canes extending from the vine at the stake outward as indicated by arrows 46. To achieve the minimum insertion gaps of ½″ for the range of bight diameters requires an angle 42 of between 7° and 30°. With maximum bight diameter and angle 42 at 45° an insertion gap of 2 13/16″ is provided.

As seen in FIGS. 4B and 4C, the tip 28 of the suspension arm is at most even with the top end 15 of the positioning shaft 12. The positioning shaft 12 may extend up to 3″ taller than the tip 28 in certain applications.

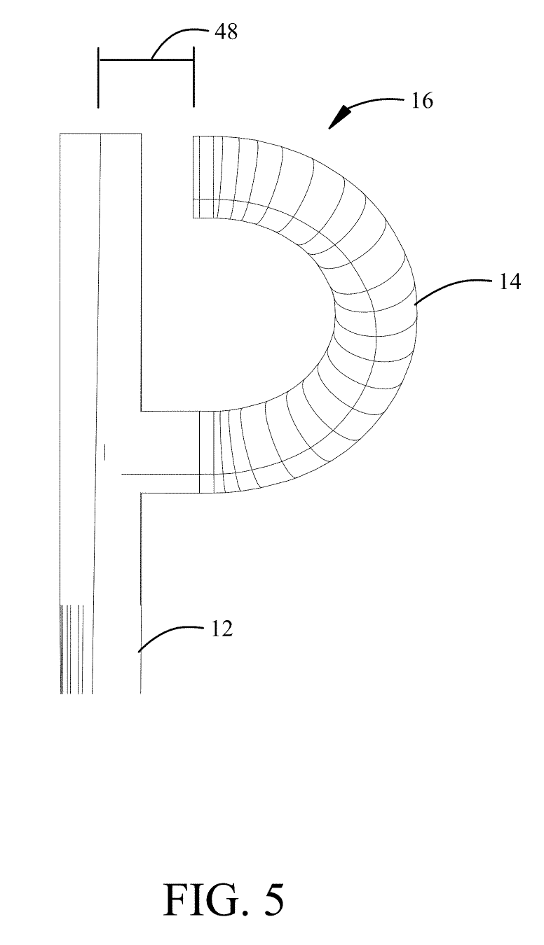

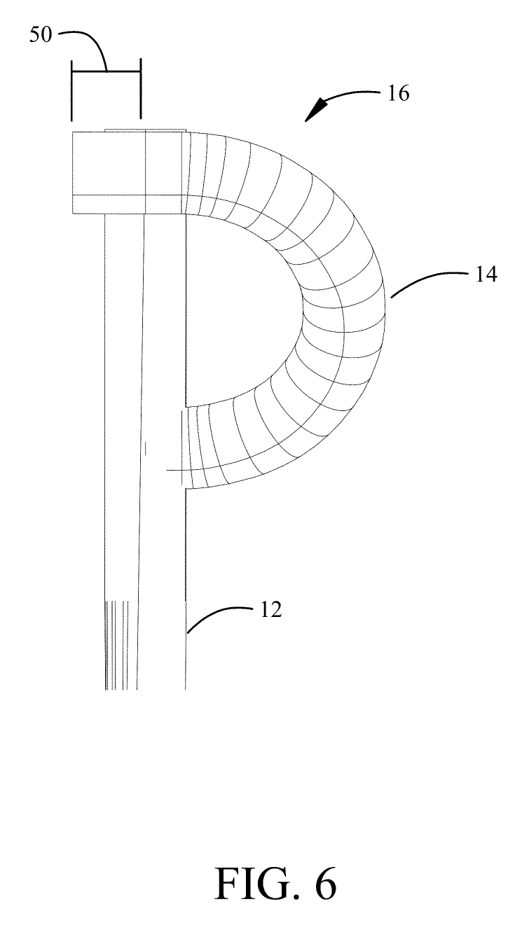

Additionally, as seen in FIGS. 4A and 4C, the tip 28 may be substantially aligned with the top end 15 of the shaft 12 along axis 26. However, in alternative embodiments, the tip 28 may be relieved from the vertical plane of axis 26 by a length 48 as seen in FIG. 5 or extended beyond the vertical plane of axis 26 by a length 50 as seen in FIG. 6. Lengths 48 and 50 may provide a ±1″ tolerance of the tip 28 with respect to the vertical plane of axis 26.

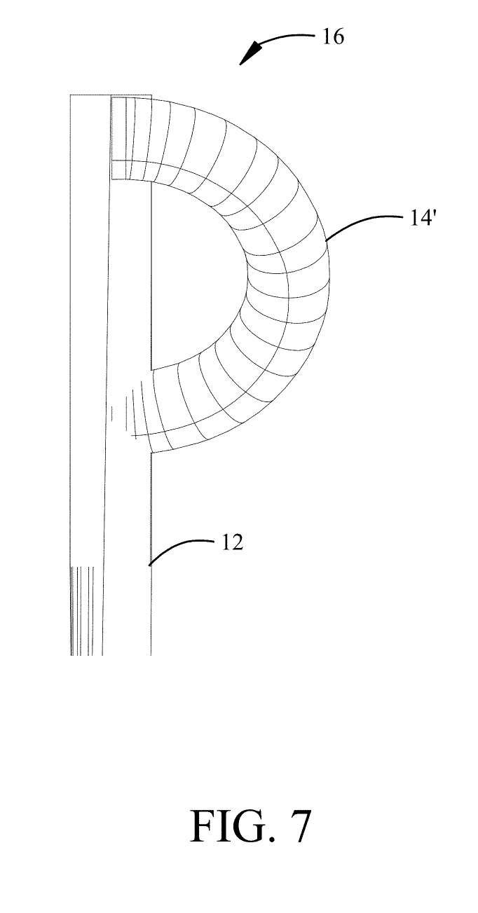

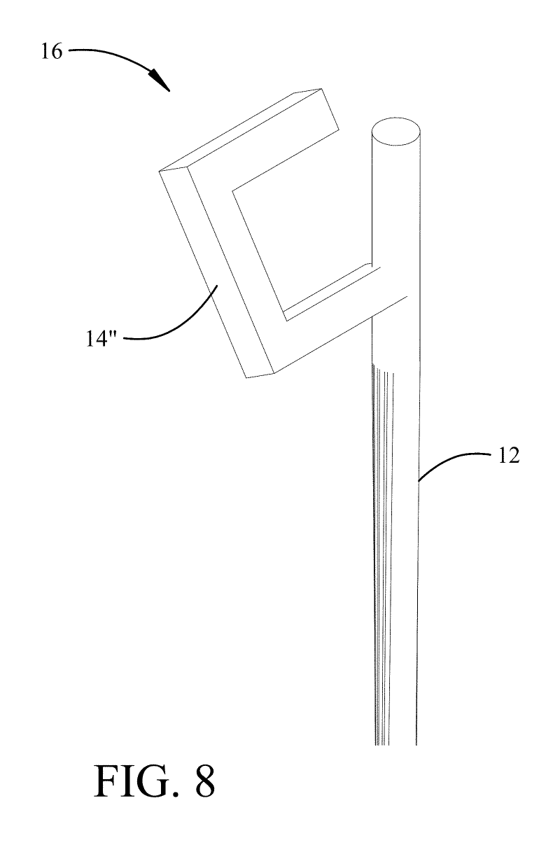

The embodiments shown in FIGS. 4A-4C, 5 and 6 have linear extensions of varying length from bight 32 to the base 24 and tip 28. As previously described, the entire suspension arm 14′ may be semicircular as seen in FIG. 7 or may be a suspension arm 14″ of rectangular planform as seen in FIG. 8. Alternative geometric shapes may be employed for the planform such as ellipsis or polygons but the added complexity of such shapes has not been shown to be of benefit.

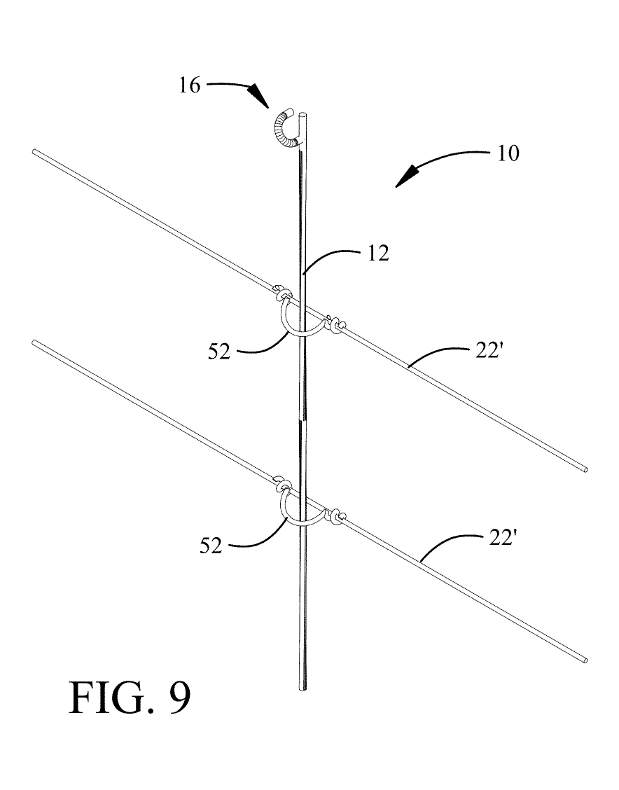

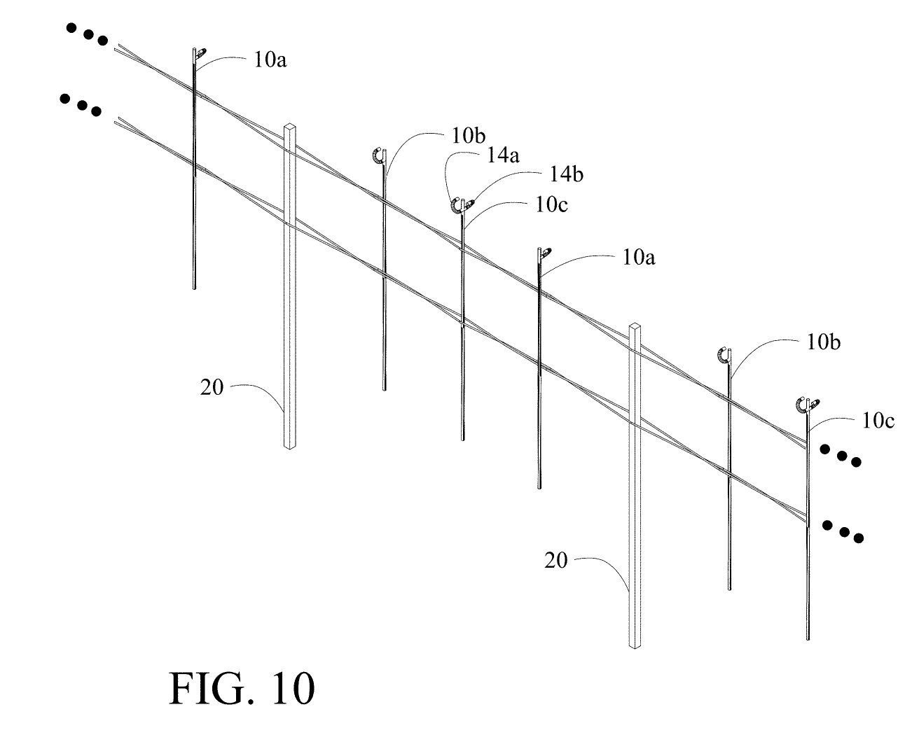

The suspension of the pedestals is provided by single wire supports 22′ as shown in FIG. 9 with the support shafts engaged by wire clips 52.

A multisection view of a trellis employing the exemplary embodiments is shown in FIG. 10. Vine stakes 20 are provided proximate the vine trunks to engage the support wires 22. Cane pedestals 10a, and 10b proximate the stakes provide a single suspension arm 14 inclined toward the stake as previously described. One or more cane pedestals 10c, as shown in FIG. 3B, may be employed with opposing suspension arms 14a and 14b each inclined toward proximate stakes or vines to separately receive extended growth of the canes.

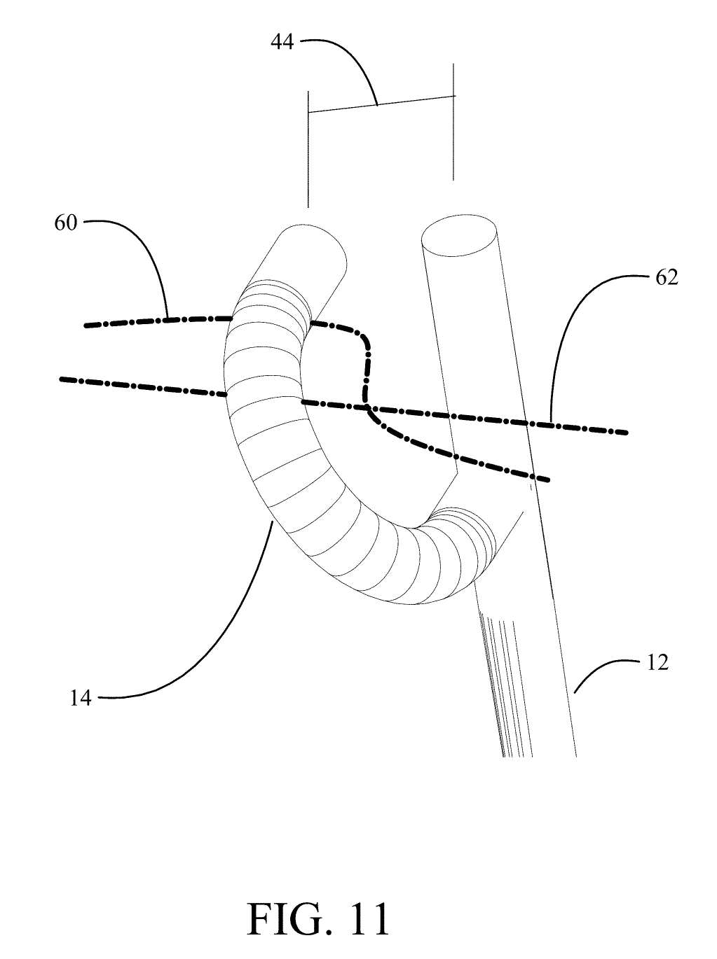

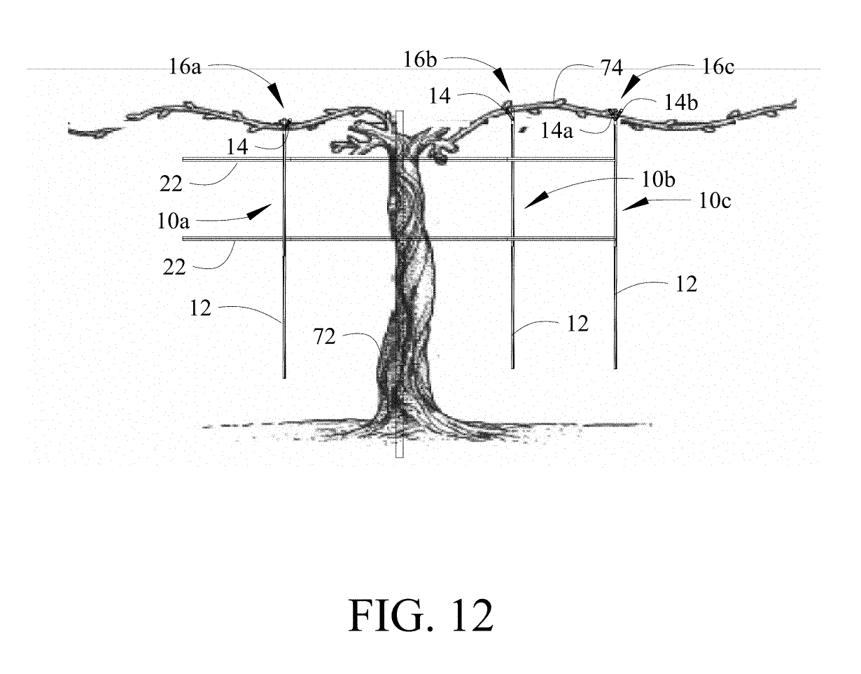

As represented in FIG. 11, the flexible canes are flexed as shown by phantom line 60 to be received through the longitudinal insertion gaps 44 into the cane receptacle 16. When released, the canes straighten as represented by phantom line 62 and are loosely supported within the cane receptacle 16. Without forcible flexing of the canes, they cannot extract themselves or fall out of the cane receptacle 16, being constrained both vertically and laterally. As previously described the loose support provided by the cane receptacle 16 allows natural pronation of the canes within supporting cane receptacle 16 during subsequent growth. FIG. 12 provides a representation of a mature, dormant, pruned grape vine having a trunk 72 adjacent a stake 20 with canes 74 extending through the cane receptacles 16a, 16b and 16c.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A cane pedestal for support of grape vine canes comprising:
a positioning shaft supported by wires extending between vine stakes, said positioning shaft extending upwardly above a top wire;
a suspension arm located proximate an upper end of the positioning shaft, said suspension arm extending from the positioning shaft and having a bight angularly oriented with respect to a vertical axis of the positioning shaft, said suspension arm, in combination with the positioning shaft comprising a cane receptacle, configured to receive and support grape vine canes.

2. The cane pedestal as defined in claim 1 wherein a base of the suspension arm connects to the positioning shaft substantially perpendicular to a vertical plane defined by a longitudinal axis extending between the vine stakes.

3. The cane pedestal as defined in claim 2 wherein a tip of the suspension arm, distal on the suspension arm from the base, is angularly offset from the vertical axis of the positioning shaft and the longitudinal axis and the vertical axis reside in the vertical plane.

4. The cane pedestal as defined in claim 3 wherein the bight extends between the base and the tip of the suspension arm.

5. The cane pedestal as defined in claim 4 wherein the suspension arm has an angle relative to the vertical axis of the positioning shaft to provide a longitudinal insertion gap between the positioning shaft and the tip of the suspension arm.

6. The cane pedestal as defined in claim 5 wherein the insertion gap is a minimum of ½″.

7. The cane pedestal as defined in claim 6 wherein the bight has an in-plane diameter of between 1″ and 4″.

8. The cane pedestal as defined in claim 6 wherein the bight has a minimum clearance between the positioning shaft and an inner surface of the bight of between ¾″ and 4″.

9. The cane pedestal as defined in claim 6 wherein the tip of the suspension arm is even with the top end of the positioning shaft.

10. The cane pedestal as defined in claim 6 wherein the top end of the positioning shaft is less than 3″ above the tip of the suspension arm.

11. The cane pedestal as defined in claim 6 wherein, the tip is relieved from the vertical plane by a length of no more than 1″.

12. The cane pedestal as defined in claim 6 wherein, the tip extends beyond the vertical plane by a length of no more than 1″.

13. The cane pedestal as defined in claim 6 wherein, the bight has a semicircular planform.

14. The cane pedestal as defined in claim 6 wherein, the bight has a rectangular planform.

15. A grape vine trellis comprising:
a plurality of vine stakes;
at least two support wires extending between the vine stakes;
a plurality of cane pedestals supported intermediate the vine stakes by the support wires, each cane pedestal having a suspension arm extending from the positioning shaft and having a bight angularly oriented with respect to a vertical axis of the positioning shaft and inclined toward an adjacent vine stake.

16. The grape vine trellis as defined in claim 15 wherein a base of the suspension arm connects to the positioning shaft substantially perpendicular to a vertical plane defined by a longitudinal axis extending between the vine stakes and a tip of the suspension arm, distal on the suspension arm from the base, is angularly offset from the vertical axis of the positioning shaft and the longitudinal axis and the vertical axis reside in the vertical plane, the bight extending between the base and the tip of the suspension arm.

17. The grape vine trellis as defined in claim 16 wherein the suspension arm has an angle relative to the vertical axis of the positioning shaft to provide a longitudinal insertion gap between the positioning shaft and the tip of the suspension arm and wherein the insertion gap is a minimum of ½″ and the bight has an in-plane diameter of between 1″ and 4″.

18. The grape vine trellis of claim 16 wherein the top end of the positioning shaft is between 0″ and 3″ above the tip of the suspension arm.

19. The grape vine trellis of claim 17 wherein the plurality of cane pedestals supported intermediate the vine stakes comprises at least three cane pedestals, a first cane pedestal proximate a first vine stake and a second cane pedestal proximate a second vine stake with at least one third cane pedestal intermediate the first and second cane pedestals, the first cane pedestal having the suspension arm extending from the positioning shaft with the bight inclined toward the first vine stake and the second cane pedestal have the suspension arm extending from the positioning shaft with the bight inclined toward the second vine stake, the at least one third cane pedestal having two suspension arms extending oppositely from the positioning shaft with a first of the two suspension arms having a bight inclined toward the first vine stake and a second of the two suspension arms having a bight inclined toward the second vine stake.
